(19) United States
(12) Patent Application Publication
(10) Pub. No.: US 2019/0013755 A1
(43) Pub. Date: Jan. 10, 2019

(54) AMBULATORY RECHARGING UNIT WITH BIONIC PNEUMATICALLY-ACTUATED GENERATOR

(71) Applicant: John Stach, Grand Rapids, MI (US)

(72) Inventor: John Stach, Grand Rapids, MI (US)

(21) Appl. No.: 15/644,411

(22) Filed: Jul. 7, 2017

(51) Int. Cl. H02P 9/04; H02J 7/00; A43B 3/00; A43B 13/20; A42B 1/24

(52) U.S. Cl. CPC H02P 9/04; H02J 7/0068; A42B 1/242; A43B 13/203; A43B 3/0015

(57) ABSTRACT

An ambulatory recharging module comprising a pneumatically-actuated or hydraulically-actuated portable induction generator for recharging a microprocessing device, the module comprising shoes having flexible reservoirs for directing compressed air or hydraulic fluid to the generator via polymeric hoses, the compressed air or hydraulic fluid driving blades within the generator and inducing a current.

### FIELD OF THE INVENTION

This invention relates to generators and recharging devices, and more particularly relates to pneumatically-actuated portable generator inducing current from compressed air.

### BACKGROUND

### Description of the Related Art

There is a need for an ambulatory, wearable recharging unit and generator to be worn by a user which harvests compressive kinetic energy alternatively applied by a user's feet while walking on a ground surface. This need arises because the proliferation of microprocessing devices has become so great that often insufficient numbers of chargers are available in residences or other fixed locations to keep the devices all charged. Even the chargers that do exist are often break, malfunction, or are lost. Although in residences electrical wall receptacles are plentiful and positioned throughout buildings to be easily accessible, these receptacles do nothing to account the need of those making use of smart phones and microprocessing devices outdoors and away from alternating current electrical B, systems, such as at parks, sporting events, concert venues, and during commutes.

Users of portable microprocessing devices face numerous challenges and inconveniences in powering and recharging small devices when away from residential buildings, including the fact that cellular phones and microprocessing devices are predominantly used while traveling and thus while away from electrical wall receptacles for charging microprocessing devices such as smart phones. Likewise, although automotive charging devices are known in the art, those in the art are of no utility to a user walking or making use of microprocessing device away from an automobile. These difficulties encountered by users of portable microprocessing devices could be substantially alleviated if an efficient portable charging station were provided which charged a mobile phone by harvesting kinetic energy of the user's body movements in a manner that did not add additional stress to body movements and if the charging unit itself were lightweight and easily ported. There is a substantial unmet need in the art for a means of effectively generating energy in this manner. There is also a need for a portable generator for powering other energy-efficient electrical devices, including LEDs. Preferably, the support would include specially-adapted shoes which expel compressed air which pneumatically actuates and induces a current in a generator forming the unit, the shoes comprising one or more inflatable bladders.

### SUMMARY

From the foregoing discussion, it should be apparent that a need exists for an efficient portable recharging system for microprocessing devices. Beneficially, such a device would overcome inefficiencies with the prior art by providing a recharging apparatus which includes a generator capable of harvesting kinetic energy from body and walking movements.

The present invention has been developed in response to the present state of the art, and in particular, in response to the problems and needs in the art that have not yet been fully solved by currently available apparti. Accordingly, the present invention has been developed to provide an ambulatory microprocessing device recharging unit, the recharging unit comprising: two shoes, each shoe comprising a sole comprising: one or more flexible air reservoirs; one or more air inlet valves; one or more air outlet valves; wherein each shoe is adapted to intake ambient air via the inlet valves when compressive force in reduced on the shoe and expel air from the outlet valves when compressive force is applied to the shoe; a plurality of flexible polymeric hoses for pneumatically interconnecting directing flow of compressed air from the outlet valves to a generator; an induction generator detachably affixed to the polymeric hoses comprising: a polymeric housing; two or more fan blades adapted to be axially rotated by compressed air delivered by the polymeric hoses; and one or more ports for bringing an electrical device into electrical contact with a current induced by the generator.

The polymeric housing may be cylindrical. In some embodiments, the polymeric housing comprises one of an open top end and an open bottom end bolted to the W housing.

The ports may comprise USB ports for bringing a microprocessing device into electrical connectivity with the generator via a charge wire. The recharging unit may further comprise one or more micro USB plugs to electrical interconnectivity between one or more LED lights and the generator.

The recharging unit may further comprise a belt clip. The recharging unit may also further comprise a plurality of Velcro straps adapted to secure the polymeric hoses to legs of the user.

The recharging unit, in still further embodiments, further comprises a hat having a micro USB port. The hat further may comprises one or more LEDs. In other embodiments, the polymeric hoses comprise one or more check valves.

In some embodiments, the polymeric hoses and one or more air reservoirs are filled with hydraulic fluid and hydraulic fluid used to power the generator.

A second ambulatory microprocessing device recharging unit is provided, the recharging unit comprising: two shoes, each shoe comprising a sole comprising: one or more flexible air reservoirs; one or more air inlet valves; one or more air outlet valves; wherein each shoe is adapted to intake ambient air via the inlet valves when compressive force in reduced on the shoe and expel air from the outlet valves when compressive force is applied to the shoe; a plurality of flexible polymeric hoses for pneumatically interconnecting directing flow of compressed air from the outlet valves to a generator, each polymeric hoses comprises one or more one-way check valves; an induction generator detachably affixed to the polymeric hoses comprising: a cylindrical polymeric housing; two or more fan blades adapted to be axially rotated by compressed air delivered by the polymeric hoses; and one or more USB ports for bringing an electrical device into electrical contact with a current induced by the generator; and a plurality of Velcro straps adapted to secure the polymeric B hoses to legs of the user.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an environmental side perspective view of a bionic portable recharging unit in accordance with the present invention;

FIG. 1B is a lower perspective view of a bionic portable recharging unit in accordance with the present invention;

FIG. 2A is a lower perspective view of the shoe of a bionic portable recharging unit in accordance with the present invention;

FIG. 2B is a side perspective view of the shoe of a bionic portable recharging unit in accordance with the present invention;

FIG. 2C is a sectioned side perspective view of the shoe of a bionic portable recharging unit in accordance with the present invention;

FIG. 2D is a sectioned side perspective view of the shoe of a bionic portable recharging unit in accordance with the present invention;

FIG. 2E is a sectioned side perspective view of the shoe of a bionic portable recharging unit in accordance with the present invention;

FIG. 3A is an elevated side perspective view of the generator of a bionic portable recharging unit in accordance with the present invention; and

FIG. 3B is a lower side perspective view of the generator of a bionic portable recharging unit in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention provide an ambulatory, wearable recharging unit and generator to be worn by a user which harvests compressive kinetic energy alternatively applied by a user's feet while walking on a ground surface.

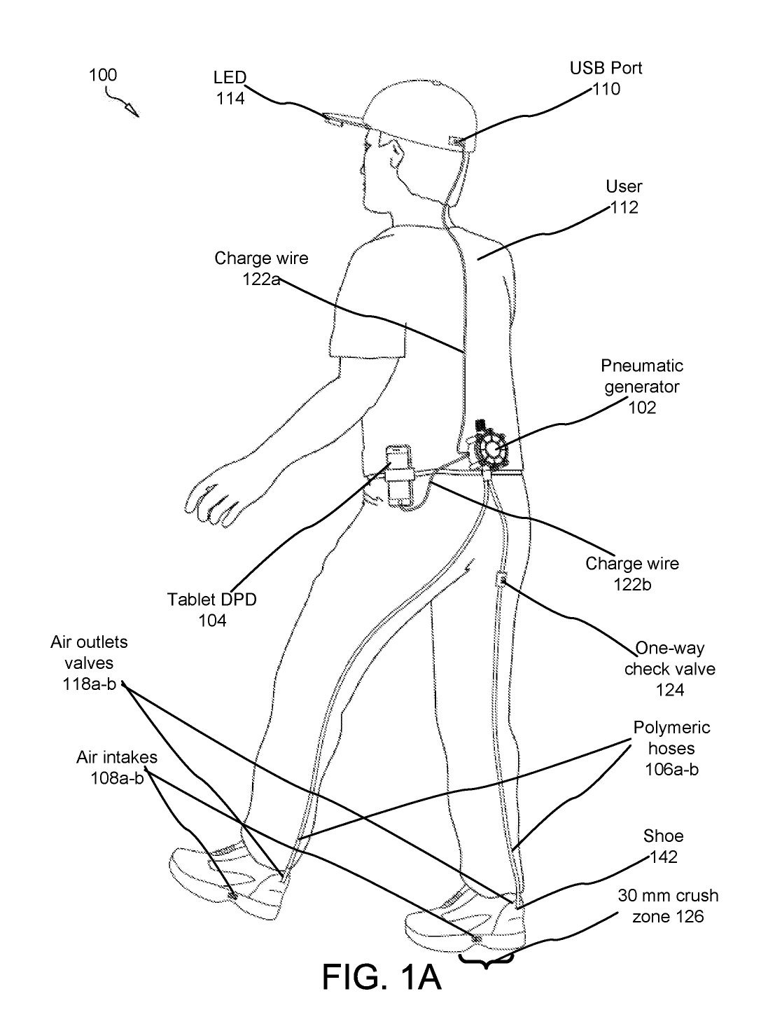

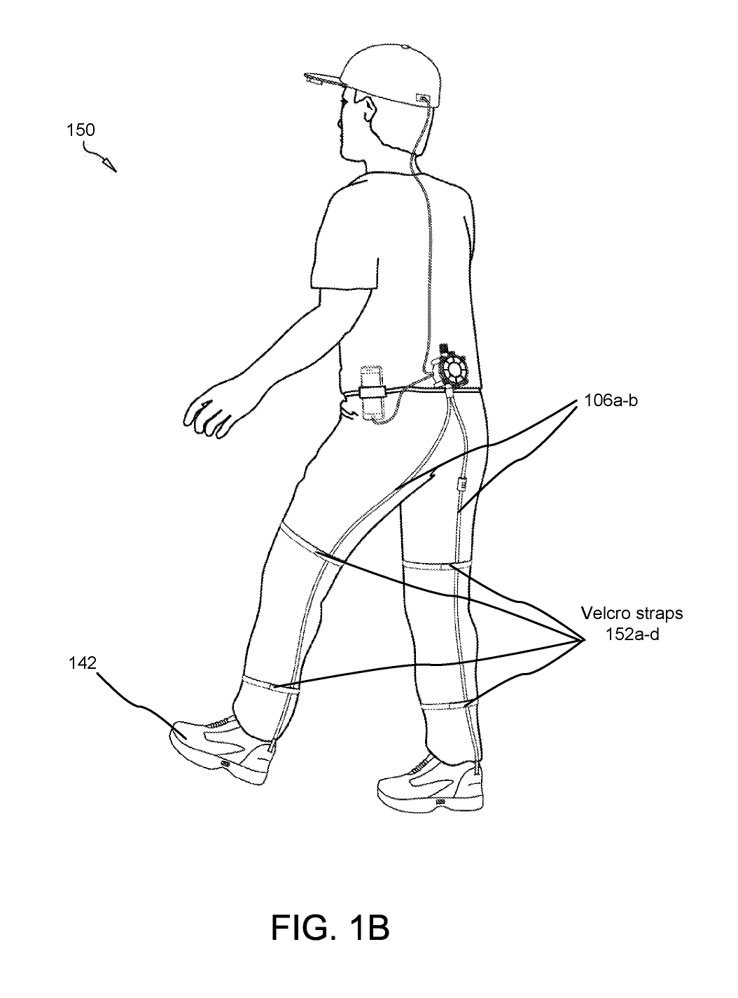

FIG. 1A is an environmental side perspective view of a bionic portable recharging unit 100 in accordance with the present invention.

The recharging unit 100 comprises two polymeric hoses 106a-b and two shoes 142 specially adapted to expel air into the hoses when the soles are compressed during walking movements.

Each shoe 142 comprises an air inlet 108 or air intake 108 which inlets air into a bladder or air reservoir contained in the sole of the shoe 142. During walking movements, when a begins lifting a foot within the shoe 142, the enclosed bladder expands and the negative pressures causes ambient air to be sucked into the bladder. The air intake 108 may comprise a one-way check valve for preventing air trapped in the bladder from be expelled back out of the air intake 108.

During walking movements, when a user takes a step and presses down on the shoe 142 and the enclosed bladder, the bladder expels compressed air from the air outlets 118 or air outlet valves 118 into the polymeric hoses 106a-b. Compressed air in the polymeric hoses 106 apply torque to a drive shaft within the generator 102 and induce a current electromagnetically using means known to those of skill in the art, including fan blades affixed to the drive shaft.

In one embodiment of the invention, the generator 102 which produces the electrical energy/current can advantageously be driven with compressed air taken from the compressed air reservoirs in the shoes 142. The volume of compressed air required to induce a current sufficient to recharge a portable microprocessing device such as a smart phone is not large. A user of average weight or more applies enough compressive force the air reservoirs in the shoes 142 to charge a microprocessing device 104 and power other energy-efficient electrical apparati such as LEDs 114 integrated into a hat or outerwear of the user (including via a micro USB port 110).

In alternative embodiments, the generator 102 powers a storage battery integrated into the generator housing until the storage battery has reached a predetermined charge or a microprocessing device 104 is connected to the generator 102.

Since the generator, the storage battery and the electrical consumer are electrically connected to one another by means of the control circuit, when the storage battery is initially discharged or exhibits a low charge, the electrical consumer is supplied with electrical energy directly by the generator, and the storage battery may be simultaneously charged with any excess electrical energy from the generator.

The induction motor, or induction generator, is included within the housing of the generator 102. The induction generator 102 operates on the principle of a rotating magnetic field. An induction generator, or asynchronous generator, is a type of electrical generator which uses the principles of induction motors to produce power and are well-known to those of skill in the art. Induction generators are useful in applications such as mini hydro power plants, wind turbines, or in reducing high-pressure gas streams to lower pressure, because they can recover energy with relatively simple controls, but have not previously been efficiently incorporated into an ambulatory recharging unit such as device 100. The induction generator 102 draws its excitation power from fan blades spun by the compressed air.

The generator 102 is in D/C electrical communication with microprocessing device 104 such as tablet DPD (data processing device) via a USB cable in the shown embodiment, but contact may be made using any means known to those of skill in the art.

In the shown embodiment, the D/C voltage is transmitted from the electrical receptacle (a USB port) at a voltage and current appropriate for recharging the portable microprocessing device 104.

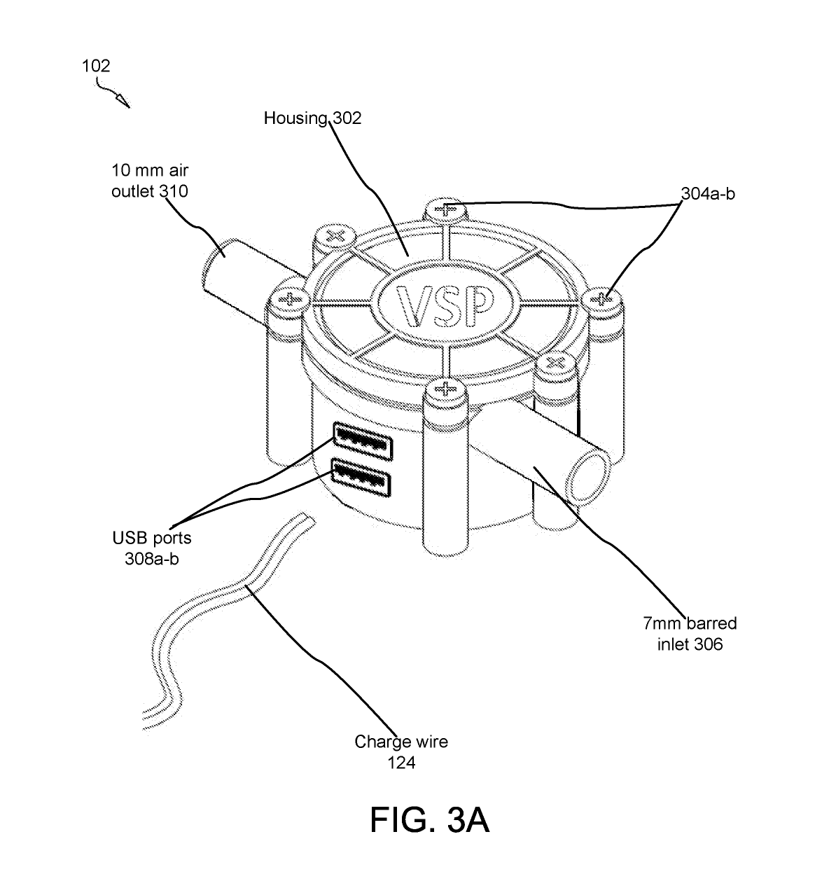

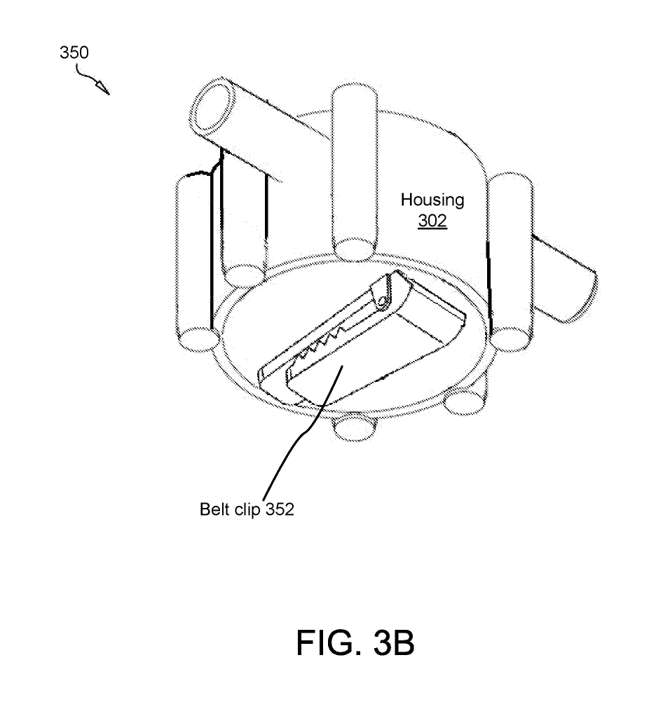

The portable microprocessing device recharging unit 100 includes a housing 102 that defines a plurality of slots for housing USB ports further described below in relation to FIG. 3, including micro USB plugs and or. In some embodiments, the device 100 comprises USB plugs or other digital plugs known to those of skill in the art.

The polymeric hoses 106 may comprise one or more one-way check valves 124 to prevent compressed air from being directed away from the generator 102.

FIG. 1B is a lower perspective view of a bionic portable recharging unit 150 in accordance with the present invention. As shown, the polymeric hoses 106a-b may be strapped to a user's body using one or more Velcro straps 152a-d. In other embodiments, the Velcro straps are substituted for straps, tubes, ties, or fasteners otherwise known to those of skill in the art, including straps incorporating buckles, snaps, carabiners, and the like.

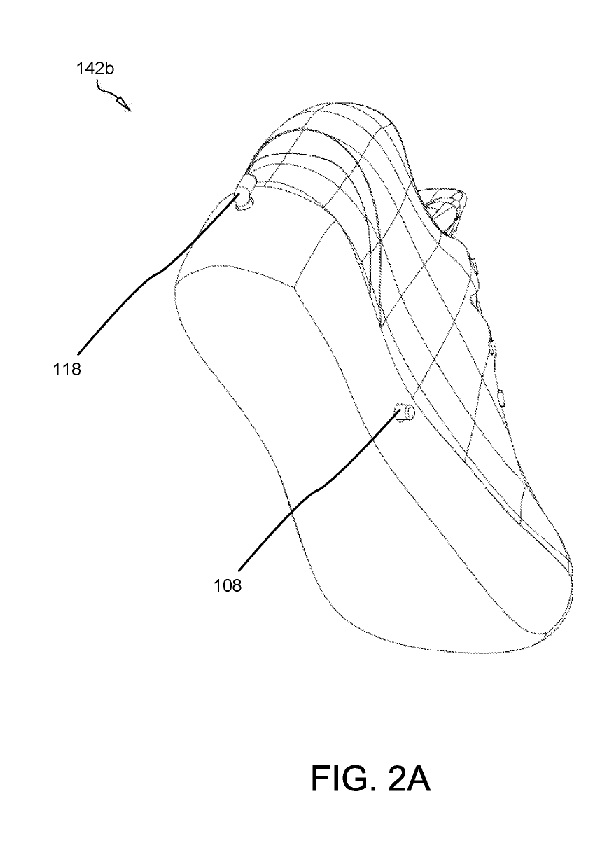

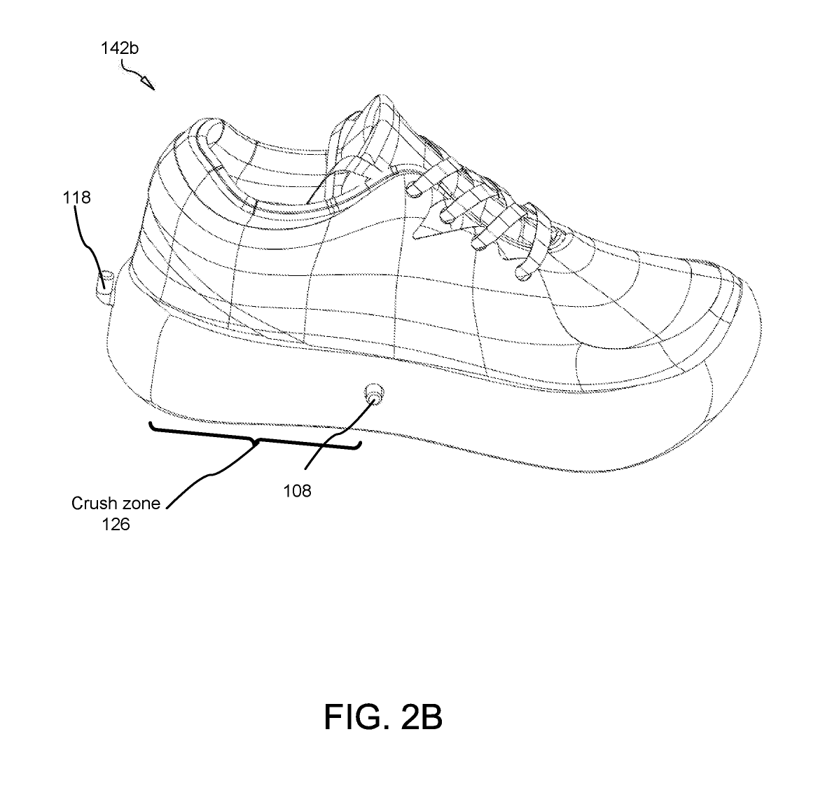

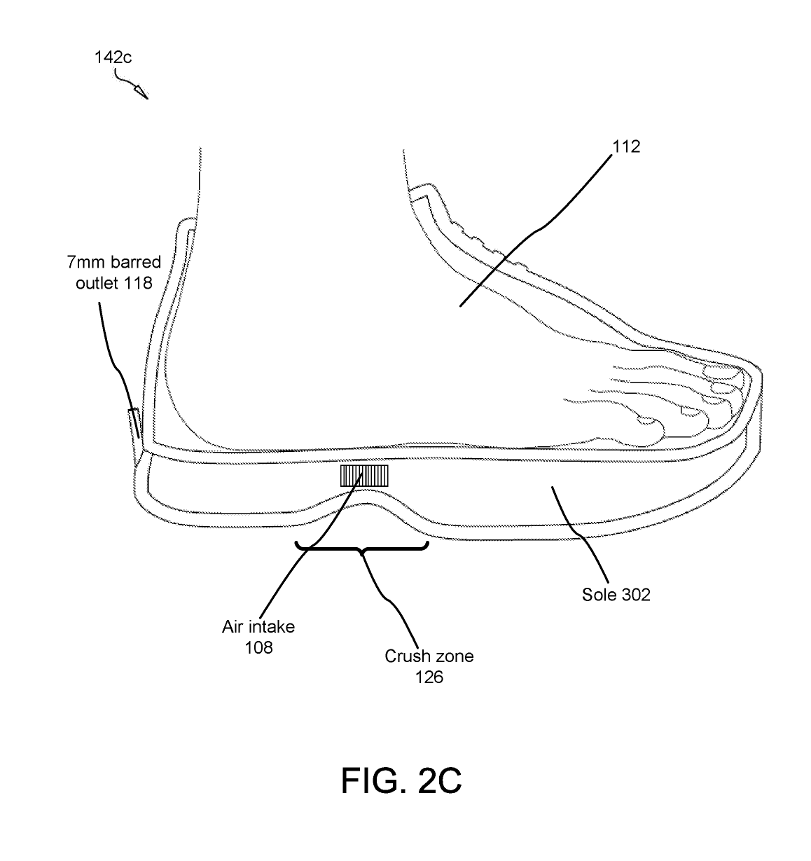

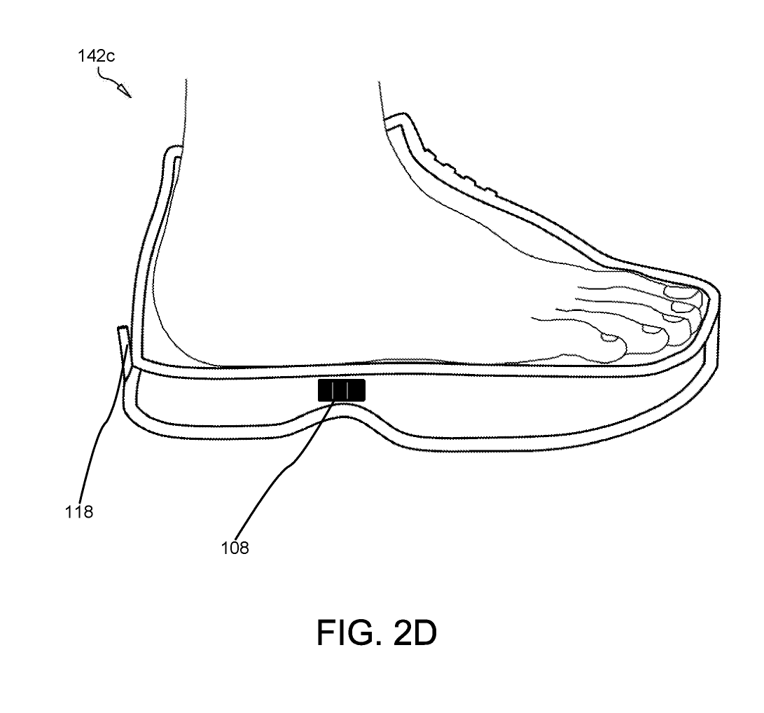

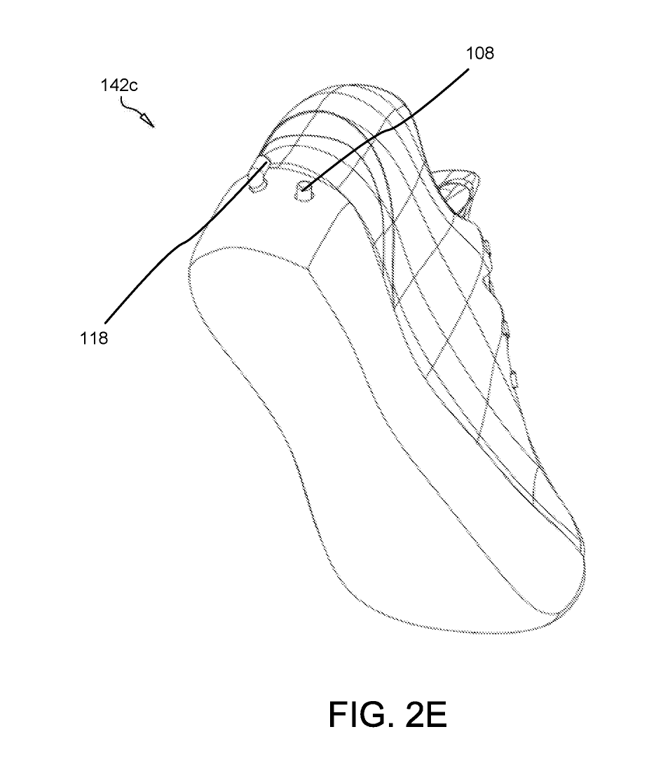

FIG. 2A is a lower perspective view of the shoe of a bionic portable recharging unit 142b in accordance with the present invention.

The shoe 142b comprises an one-way inlet value 108 and a one-way outlet valve 118. The shoe 142b and sole are specially adapted to force compressed air into the generator 102.

FIG. 2B is a side perspective view of the shoe of a bionic portable recharging unit in accordance with the present invention.

As shown, the crush zone 126 is the portion of the shoe in which the air reservoir is disposed and the portion which receives the maximum compressive force from the downward application of the user's foot.

The crush zone 126 may be 30 millimeters in length across a lengthwise axis. The air intake 108 may comprise a vent, a plurality of vents, a one way valve, a plurality of one way valves, and other means known to those of skill in the art for inletting air into a flexible bladder or air reservoir.

FIG. 2C is a sectioned side perspective view of the shoe of a bionic portable recharging unit in accordance with the present invention.

FIG. 2D is a sectioned side perspective view of the shoe of a bionic portable recharging unit in accordance with the present invention.

The air intake 108 may be disposed anywhere along the periphery of the sole of the shoe 142c.

FIG. 2E is a sectioned side perspective view of the shoe of a bionic portable recharging unit in accordance with the present invention. As shown, the air intake 108 may a be positioned on the high end of the heal of the shoe near the air outlet 118. This is to reduce the risk of particulates or standing water on a ground surface or subgrade from being sucked into the air reservoir, including sand and snow.

In other embodiments of the present invention, the air reservoir in the shoe is filled with a liquid such as water or hydraulic fluid and a generator is spun creating current when the fluid is forced through it. The polymeric hoses 106 are used as, or substituted for, hydraulic lines.

FIG. 3A is an elevated side perspective view of the generator 102 of a bionic portable recharging unit in accordance with the present invention.

The generator 102 comprises a cylindrical generator housing 302 having an closed top end and closed bottom end. In various embodiments, one or more of the top end and the bottom end may be bolted to the main portion of the housing 302 using bolts 304. The housing 302 may be fabricated from any polymeric, metal alloy, or organic material, including nylon, aluminum and leather. The housing 302 in the shown embodiment is cylindrical to house axially rotating fan blades; but, in various embodiments, the housing 102 forms a cubic shape, square or rectangular from a forward perspective view. Fan blades within the generator may be affixed an axle torsionally driven by the compressed air from the air reservoirs in the shoes 142.

The portable generator 102 includes a plurality of slots for housing USB ports 308 and/or other digital plugs known to those of skill in the art. Standard USB cables are inserted into the slots 308 to bring a microprocessing device 104 into electrical connectivity with the generator 102.

The generator, the storage battery and any electrical control circuit(s) may be advantageously grouped together in the single housing 302.

FIG. 3B is a lower side perspective view of the generator of a bionic portable recharging unit in accordance with the present invention.

The lower surface, or closed bottom end, of the housing 302 is affixed to a belt clip 352. The lower surface comprises attachment means for detachably affixing the generator housing 302 to outwear of a user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An ambulatory microprocessing device recharging unit, the recharging unit comprising:
two shoes, each shoe comprising a sole comprising:
one or more flexible air reservoirs;
one or more air inlet valves;
one or more air outlet valves;
wherein each shoe is adapted to intake ambient air via the inlet valves when compressive force in reduced on the shoe and expel air from the outlet valves when compressive force is applied to the shoe;
a plurality of flexible polymeric hoses for pneumatically interconnecting directing flow of compressed air from the outlet valves to a generator;
an induction generator detachably affixed to the polymeric hoses comprising:
a polymeric housing;
two or more fan blades adapted to be axially rotated by compressed air delivered by the polymeric hoses;
and one or more ports for bringing an electrical device into electrical contact with a current induced by the generator.

2. The recharging unit of claim 1, wherein the polymeric housing is cylindrical.

3. The recharging unit of claim 1, wherein the polymeric housing comprises one of an open top end and an open bottom end bolted to the housing.

4. The recharging unit of claim 1, wherein the ports comprise USB ports for bringing a microprocessing device into electrical connectivity with the generator via a charge wire.

5. The recharging unit of claim 1, further comprising one or more micro USB plugs to electrical interconnectivity between one or more LED lights and the generator.

6. The recharging unit of claim 1, further comprising a belt clip.

7. The recharging unit of claim 1, further comprising a plurality of Velcro straps adapted to secure the polymeric hoses to legs of the user.

8. The recharging unit of claim 1, further comprising a hat having a micro USB port.

9. The recharging unit of claim 9, wherein the hat further comprises one or more LEDs.

10. The recharging unit of claim 1, wherein the polymeric hoses comprise one or more check valves.

11. The recharging unit of claim 1, wherein the polymeric hoses and one or more air reservoirs are filled with hydraulic fluid and hydraulic fluid used to power the generator.

12. An ambulatory microprocessing device recharging unit, the recharging unit comprising:
two shoes, each shoe comprising a sole comprising:
one or more flexible air reservoirs;
one or more air inlet valves;
one or more air outlet valves;
wherein each shoe is adapted to intake ambient air via the inlet valves when compressive force in reduced on the shoe and expel air from the outlet valves when compressive force is applied to the shoe;
a plurality of flexible polymeric hoses for pneumatically interconnecting directing flow of compressed air from the outlet valves to a generator, each polymeric hoses comprises one or more one-way check valves;
an induction generator detachably affixed to the polymeric hoses comprising:
a cylindrical polymeric housing;
two or more fan blades adapted to be axially rotated by compressed air delivered by the polymeric hoses;
and one or more USB ports for bringing an electrical device into electrical contact with a current induced by the generator; and
a plurality of Velcro straps adapted to secure the polymeric hoses to legs of the user.
